(19) United States
(12) Patent Application Publication
(10) Pub. No.: US 2009/0024372 A1
(43) Pub. Date: Jan. 22, 2009

(54) METHOD OF IDENTIFYING REUSABLE SERVICES THROUGH MODELLING A BUSINESS PROCESS AND COMMONALITIES IN PROCESS FLOWS

(76) Inventors: Jane Chen, Malvern East (AU); Peter Glen Bittner, Aspendale (AU)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/780,362

(22) Filed: Jul. 19, 2007

(51) Int. Cl. G06G 7/48

(52) U.S. Cl. 703/6

(57) ABSTRACT

In one aspect, the invention is directed to a method for identifying potential integration points within an enterprise system. The method involves reviewing process flows from a business process model and identifying groups of process flows that have at least a selected degree of commonality in their contained information elements. Any groups of process flows having at least the selected degree of commonality are identified as potential integration points from which one or more potential reusable services may be identified.

### FIELD OF THE INVENTION

The invention relates to the field of moving a business entity towards a service-oriented architecture and more particularly to identifying potential areas for exposure as services.

### BACKGROUND OF THE INVENTION

A step in the process of moving a business entity over to a service-oriented architecture is the modeling of the business process, including the decomposition of the business process into a set of process elements. The process elements are reviewed and evaluated as to whether or not they warrant exposure as a service.

In general, there is a continuing need for improvement in the identification of candidate services in a business process.

### SUMMARY OF THE INVENTION

In one aspect, the invention is directed to a method for identifying potential integration points within an enterprise system. The method involves reviewing process flows from a business process model and identifying groups of process flows that have at least a selected degree of commonality in their contained information elements. Groups of process flows having at least the selected degree of commonality are identified as potential integration points. In a particular embodiment, the method comprises:

providing a suitably formatted business process model, the business process model comprising a plurality of interdependent process steps, wherein a plurality of components are provided, each component being configured to carry out at least one process step, wherein the plurality of components are connected together by a plurality of process flows, each process flow containing at least one information element selected from the group consisting of instructions and data between the process steps;

identifying a group of process flows having at least a selected quantity of information elements in common; and

recording the group of process flows as a potential integration point.

In another aspect, the invention is directed to a data processing system for implementing the method described above.

In another aspect, the invention is directed to a computer program product with computer-usable program code for implementing the method described above.

### BRIEF DESCRIPTION OF THE DRAWINGS

For a better understanding of the present invention, and to show more clearly how it may be carried into effect, reference will now be made, by way of example, to the accompanying drawings in which:

FIG. 1 is a pictorial representation of a data processing system in which aspects of the present invention may be implemented;

FIG. 2 is a block diagram of a data processing system in which aspects of the present invention may be implemented;

FIG. 3 is a flow diagram of a method of developing a service model for a business in accordance with a first aspect of the invention;

FIG. 4 is a business process model of a business;

FIG. 5 is a Service Oriented Package Integration Model relating to the business process model shown in FIG. 4;

FIG. 6 is a service model relating to the business process model shown in FIG. 4 and the Service Oriented Package Integration Model shown in FIG. 5;

FIG. 7a is another business process model;

FIG. 7b is a service model relating to the business process model shown in FIG. 7a;

FIG. 7c is another service model relating to the business process model shown in FIG. 7a; and

FIG. 8 is a flow diagram of a method of identifying potential integration points within an enterprise system.

### DETAILED DESCRIPTION OF THE INVENTION

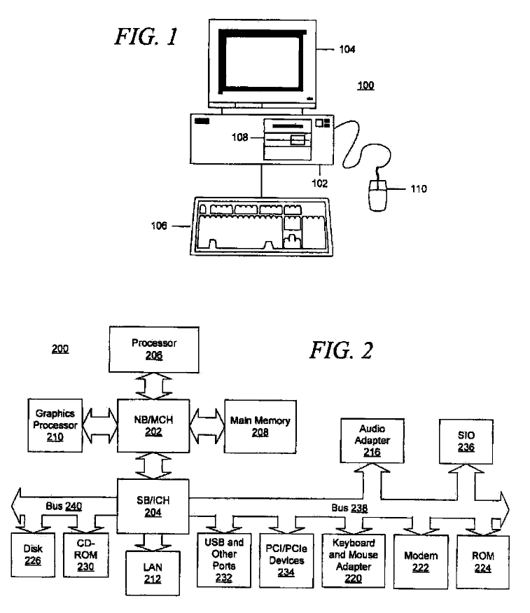

FIG. 1 is a pictorial representation of a data processing system in which aspects of the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 may be implemented using any suitable computer, such as an IBM® eServer computer or IntelliStation® computer, which are products of International Business Machines Corporation, located in Armonk, N.Y. Although the depicted representation shows a personal computer, exemplary aspects of the present invention may be implemented in other types of data processing systems, such as laptop computers, palmtop computers, handheld computers, network computers, servers, workstations, cellular telephones and similar wireless devices, personal digital assistants and other electronic devices on which software programs may be installed. Computer 100 also preferably includes a graphical user interface (GUI) that may be implemented by means of systems software residing in computer readable media in operation within computer 100.

With reference now to FIG. 2, a block diagram of a data processing system is shown in which aspects of the present invention may be implemented. Data processing system 200 is an example of a computer, such as personal computer 100 in FIG. 1, in which code or instructions implementing the processes of the exemplary aspects may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH 202 through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 424, universal serial bus (USB) ports and other communications ports 232, and PCI/PCIe devices 234 connect to south bridge and I/O controller hub 204 through bus 238. Hard disk drive (HDD) 226 and CD-ROM drive 230 connect to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to south bridge and I/O controller hub 204.

A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. (Java and all Java-based trademarks are trademarks of Sun Microsystems, Inc. in the United States, other countries, or both.)

Instructions for the operating system, the object-oriented programming system, and applications or programs are located on storage devices, such as hard disk drive 226, and may be loaded into main memory 208 for execution by processor 206. Aspects of the present invention may be performed by processor 206 using computer implemented instructions, which may be located in a memory such as, for example, main memory 208, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which may be configured with flash memory to provide non-volatile memory for storing operating system files and/or user-generated data. A memory may be, for example, main memory 208 or a cache such as found in north bridge and memory controller hub 202. A processing unit may include one or more processors. The depicted examples in FIGS. 1-2 and above-described examples are not meant to imply architectural limitations. For example, data processing system 200 also may be a tablet computer, laptop computer, or telephone device in addition to taking the form of a PDA.

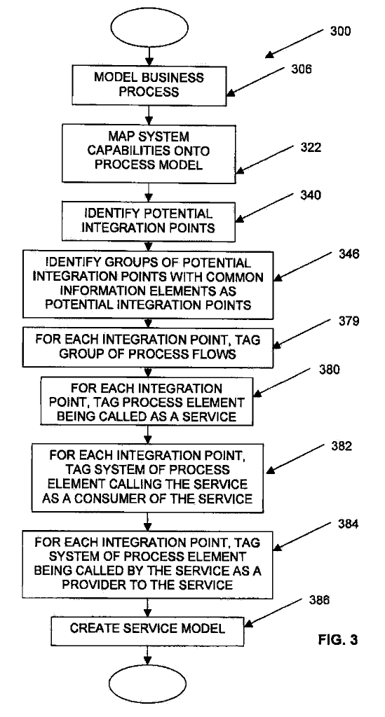

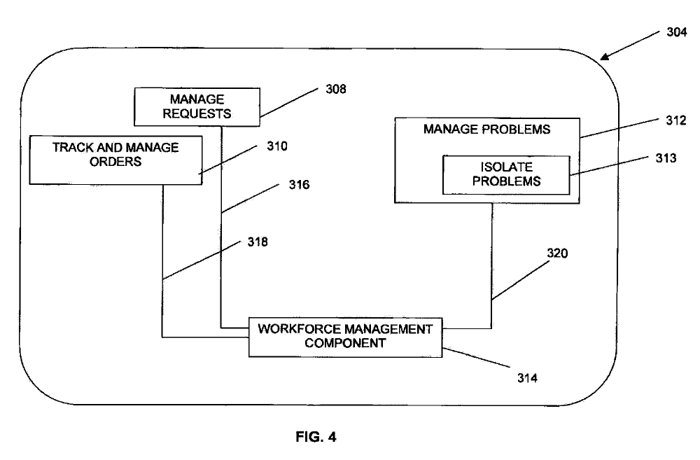

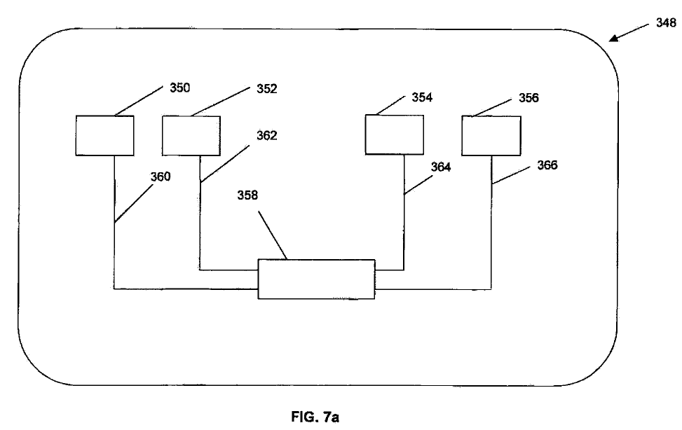

Reference is made to FIG. 3, which shows a flow diagram representing a method 300 of developing a service model 302 (see FIG. 6) for a business, which may also be referred to as an enterprise system. An initial step in the method 300 is to develop a business process model 304 (FIG. 4) for the business, as shown at step 306. The business process model 304 (FIG. 4) is a model of the processes that make up the business. These processes may include internal processes which are purely internal to the business and public processes which involve interaction with entities outside the business, such as customers. The exemplary business process model 304 relates only to a portion of the business processes that exist in a typical business and is for illustrative purposes only. It will be understood that the method 300 can be applied to a portion of a business or to the entirety of a business.

The business process model 304 includes a process step 308 for receiving and handling customer requests, a process step 310 for tracking and handling existing customer orders, a process step 312 for receiving and handling customer complaints, and a process step 314 for managing the workforce of the business. The process step 308 for receiving and handling customer requests may entail, for example, receiving input from a customer regarding one or more products through the Internet, and providing information to customers based on their input. In the event that a customer requests an appointment with a representative from the business, the process flow proceeds at 316, from the process step 308 to the workforce management process step 314 to determine availability of a representative from the business and to schedule an appointment.

The process step 310 for tracking and handling existing orders for customers may entail interfacing with a production schedule, an inventory management system, an engineering schedule, and/or several other elements to determine, among other things, when an order is likely to be completed. In the process step 312 the customer may request a confirmation of a pre-existing appointment. For example, depending on the nature of the product or service being sold by the business, it may be pre-arranged at the time the order is placed that an appointment will take place upon order completion. In such an embodiment, the customer may, at some point after having placed an order, request confirmation that the appointment that was pre-arranged will still take place at the scheduled date and time. In the process model 300, the process flow at this point would proceed at 318 to the workforce management process step 314, which would issue a response to the confirmation request. The response could be, for example, a confirmation of the appointment, or, for example, an indication that the appointment needs to be moved or canceled.

The problem management process step 312 relates to handling problems that arise with a customer order. Among other things, the process step 312 isolates the customer problem, shown at a process step 313 that makes up a part of the problem handling process step 312. At some point in the problem handling process step 312, such as, for example, once the problem has been isolated, a request may be made to the workforce management process step 314 to (for example) create a customer appointment to review the problem. Alternatively, if a customer appointment had already been scheduled, but needs to be changed or cancelled, a request may be made to that effect to the workforce management process step 314. The process flow relating to the request from the problem management process step 312 is shown at 320. It is possible that the request to create, change or cancel the appointment could originate from within the problem management process step 312 itself, and so this request may require handling in a different way than a customer driven request. In other words, the data and instructions contained in the process flow 320 may differ from the data and instructions contained in the process flow 316, even though both relate to a request for an appointment. For example, the data included in the process flow 316 wherein a customer requests an appointment, may include a date for the appointment. However, the data included in the process flow 320 might not include a date if the request originated from within the problem management process step 312.

In a preferred embodiment, the process model 304 is a generic process model, in the sense that it describes the entirety of the process it models, and not simply some particular path in the process. For example, the process model 300 preferably models the entirety of the order handling process, and not just orders for a particular type of product or service.

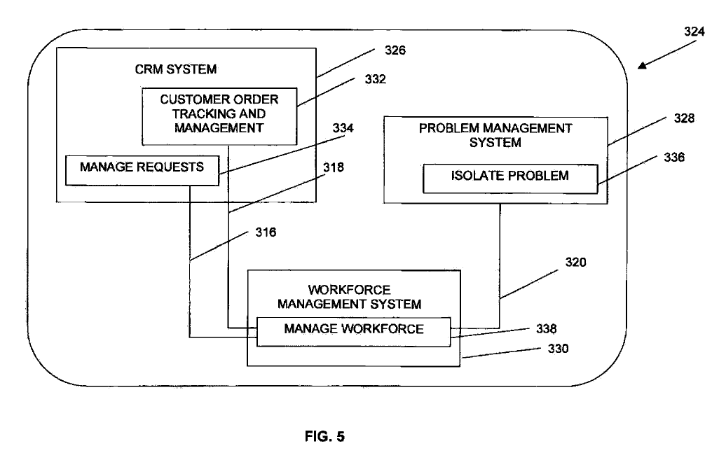

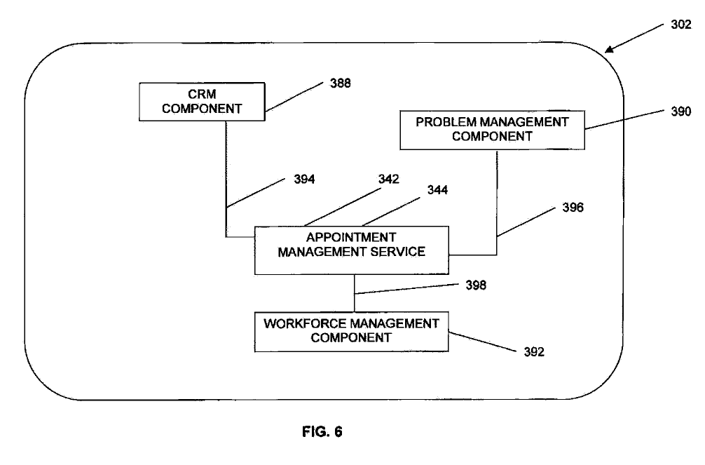

Referring to FIG. 3, at step 322, the current system capabilities of the business are mapped onto the process model 300 (FIG. 4). The current system capabilities include whatever systems the business has that can perform the processes described in the process model, thereby producing a Service Oriented Package Integration Model, shown at 324 in FIG. 5.

The exemplary systems shown in the Service Oriented Package Integration Model include, for example, a Customer Relationship Management (CRM) system, shown at 326, a problem management system 328 and a workforce management system 330. The CRM system 326 may include an order tracking and management component 332 that performs, for example, the order tracking and management process step 310 (FIG. 4), and a customer request management component 334 that performs the customer request handling process step 308 (FIG. 4). The problem management system 328 may include a problem isolation component 336 that performs the problem isolation process step 313 (FIG. 4). The workforce management system 330 may include a workforce management component 338 that handles the scheduling of the workforce, including the scheduling of appointments with customers. Additionally, the workforce management component 338 may handle the steps of responding to the requests to create, change, cancel and confirm appointments. It is alternatively possible, however, that the scheduling of appointments and the responding to the requests from the other systems (i.e. the CRM system 326 and the problem management system 328) may be performed by a plurality of components (not shown) that make up the workforce management system 330.

Referring to FIG. 3, at step 340, the Service Oriented Package Integration Model 324 (FIG. 4) is reviewed to identify potential integration points. An integration point is a point at which a service could be positioned to handle a plurality of like process flows. For example, upon review of the Service Oriented Package Integration Model 324 shown in FIG. 5, one can identify at least one potential integration point, which relates to the process flows 316 and 320. The process flows 316 and 320 carry instructions selected from the same set of possible instructions (e.g. request appointment, change appointment, cancel appointment) and the same data (e.g. name of requester, subject of meeting, proposed date for meeting, proposed venue for meeting). A potential service shown at 342 in FIG. 6 could be provided that would receive the process flows 316 and 320 (FIG. 5) that would handle the requests contained in those process flows 316 and 320. The potential service 342 (FIG. 6) may, in this instance, be an appointment management service. The potential service 342 represents a potential integration point 344 for the process flows 316 and 320 (FIG. 5).

It is optionally possible to identify a potential integration point for a plurality of process flows that are not entirely the same in terms of the data or instructions they contain. For example, the process flow 318 (FIG. 5) contains an instruction (eg. a request for confirmation of an appointment). The data contained in the process flow 318 may include, for example, the name of the requester, the date of the appointment and the name of the representative from the business that is scheduled to meet the customer. The contained instruction is not included in the set of possible instructions for either of the process flows 316 or 320. The data, however, has several things in common with the data contained in the process flows 316 and 320, such as the name of the requester and the date of the appointment. Thus, it is optionally possible for the appointment management service 342 to have the expanded capability of handling confirmation requests in addition to handling appointment creation requests, appointment change requests and appointment cancellation requests.

The appointment management service 342 may be provided in any suitable way. For example, it may be a newly created service that requires new code to be written. Alternatively, the appointment management service 340 could be provided from largely pre-existing code, perhaps one or more components that already exist within the workforce management system 330. In the aforementioned situation where the appointment management service 342 is provided from pre-existing code, a suitable adapter may be written or otherwise provided so that the code conforms to the standards required of the service oriented architecture associated with the business.

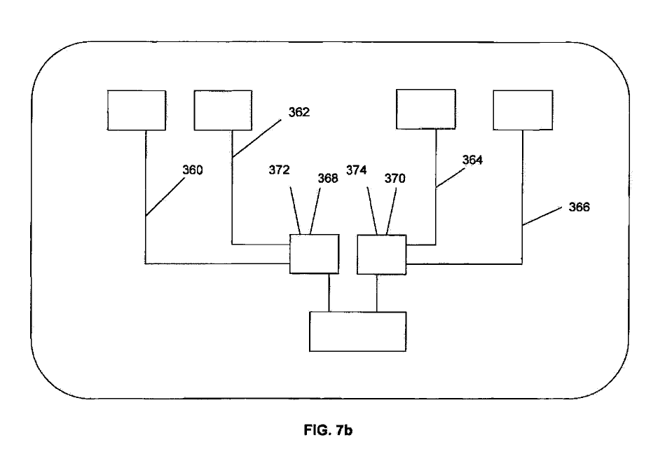

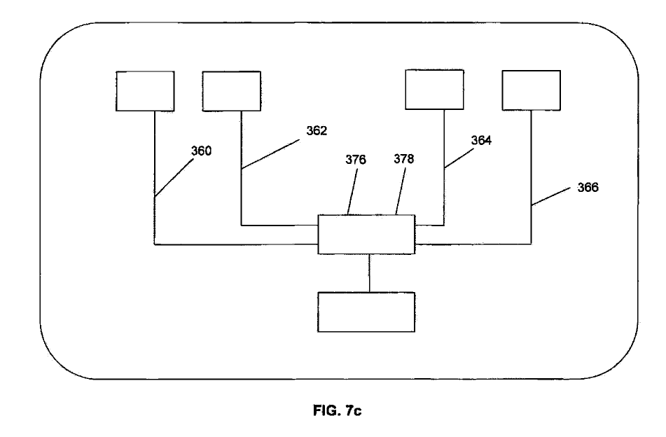

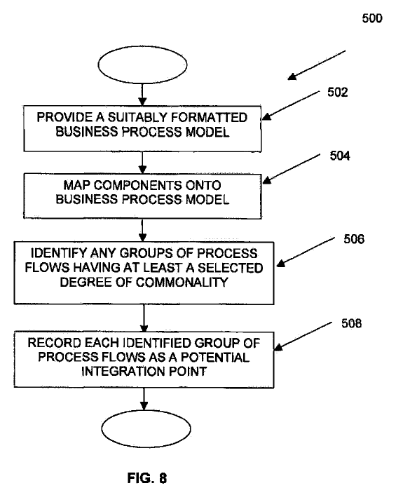

Referring to FIG. 3, at step 346, the Service Oriented Package Integration Model is optionally further reviewed to identify groups of integration points that are sufficiently similar as to warrant their integration with each other. For example, as shown in FIG. 7a, a Service Oriented Package Integration Model 348 may include several systems, including a first system 350, a second system 352, a third system 354 and a fourth system 356. For simplicity a detailed description of each of the systems 350, 352, 354 and 356 is not provided. The first system 350 and the second system 352 both can be used to send an appointment confirmation request to the workforce management system, shown at 358, through process flows 360 and 362. The third and fourth systems 354 and 356 both can be used to send requests for new appointments to the workforce management system 358, through process flows 364 and 366. Thus, when the Service Oriented Package Integration Model 348 is reviewed, two potential integration points 368 and 370 (see FIG. 7b) may be identified, and two potential services 372 and 374 may be identified, relating to confirmation of appointments, and to creation of appointments respectively. Upon review of the integration points 368 and 370 it may be determined that they have a sufficient degree of commonality, (i.e. commonality in their data and/or their instructions), that they can be partially or completely integrated themselves into a service 376 (see FIG. 7c) for managing appointments at an integration point 378.

The decision as to whether or not to integrate the process flows involved in the integration points 368 and 370 (FIG. 7b) at the integration point 378 (FIG. 7c) may depend on several factors, including, but not limited to, the quantity of shared information in the process flows associated with each, namely the process flows 360 and 362 (FIG. 7a), and 364 and 366 respectively. For example, the decision to integrate the integration points 368 and 370 (FIG. 7b) could be based on whether the process flows 360 and 362 (FIG. 7a) have more than a selected percentage of information elements in common with the process flows 364 and 366 (‘information elements’ is the term denoting instructions and data that make up a process flow). Alternatively, for example, the decision to integrate the integration points 368 and 370 (FIG. 7b) could be based on whether the process flows 360 and 362 (FIG. 7a) share more than a selected number of discrete information elements with the process flows 364 and 366.

It will also be understood that at any integration point, more than one service may be created or identified to handle the process flows being integrated. For example, where the process flows are not identical in their makeup, a first service may be defined to handle the portion of the process flows that is common to all of them, and then a second service may be defined to handle portions of those process flows that are not common.

Referring to FIG. 3, at step 379, for each integration point that is selected to have a service created, the group of process flows that are to be integrated in the newly defined service is tagged. At step 380, the newly defined service (e.g. service 342 shown in FIG. 6) or services (e.g. services 372 and 374 shown in FIG. 7b), are tagged for inclusion in the SOA of the business. At step 382, the system or systems that called the newly defined service (e.g. the systems 326 and 328 shown in FIG. 5) are tagged as consumers of the service. At step 384, the system or systems that are called by the newly defined service are tagged as providers to the service (e.g. system 330 (shown in FIG. 5). It will be understood that more than one system may be a provider to the newly defined service.

Referring to FIG. 3, at step 386, the service model 302 (FIG. 6) of the business is developed from the Service Oriented Package Integration Model. The service model 302 shows a plurality of components each of which is a consumer of the potential service 342 or a provider to a service 342. In the embodiment shown in FIG. 6, the components include a CRM component 388, a problem management component 390 and a workforce management component 392. The CRM component 388 is a consumer of the potential service 342 and may request a confirmation of an appointment, a new appointment, a change to an appointment or a cancellation of an appointment. The process flow from the CRM component 388 is shown at 394. Similarly to the CRM component 388, the problem management component 390 may request a new appointment, a change to an appointment or a cancellation of an appointment through process flow 396, and is therefore a consumer of the service 344.

The workforce management component 392 is a provider to the appointment management service 342. For example, the workforce management component 392 may include a schedule containing travel plans for all of the employees of the business. The appointment management service 342 may request confirmation from the workforce management component 392 as to whether the particular employee is away traveling or not, as part of determining the employee's availability for a requested appointment. The process flow from the appointment management service 342 to the workforce management service 392 is shown at 398.

It will be understood that many of the process steps described herein are themselves composed of other process steps. The appropriate level of granulation that is shown in the business process model 300 (i.e. the size of the steps into which the business process is broken down) will be apparent to one skilled in the art once informed by the disclosure herein, and is based on the extent to which the person analyzing the business wishes to optimize the business using a service-oriented architecture.

As noted above, the process model 300 is preferably generic, in the sense that it preferably represents the entire process for the entire business. By covering the entire process for the entire business, one maximizes the opportunity to find groups of process flows that contain the same or similar information elements, thereby maximizing the opportunity to find potential reusable services to incorporate into the service model 302. By contrast, if the process model only covers a portion of the business, there is some risk that process flows would be separated from other similar or identical process flows from a portion of the business that is not represented in the process model. As a result, some opportunities to identify potential services for incorporation into the service model would be missed. It is nonetheless within the scope of one aspect of the invention to identify potential services based on process flows taken even from a portion of the business. It is of some advantage to provide a process model relating to a relatively well-defined portion of the business, such as customer relationship management, or engineering, since there may be some likelihood that similar process flows will be contained within a well-defined portion of the business.

Reference is made to FIG. 8, which illustrates a method 500 finding and identifying potential integration points for an enterprise system, and for finding and identifying reusable services, which is particularly suited for automated execution by software for example. At step 502, a business process model is provided, which may be, for example, the business process model 304 shown in FIG. 4. The business process model is suitably formatted for the software in embodiments wherein the method 500 is carried out by software. The business process model need not be generated by the software carrying out the method; it may be received by the software from some other source. The business process model contains the process steps and process flow information describing preferably either the entirety of the business, or the entirety of some aspect of the business, thereby increasing the likelihood of finding and identifying reusable services. Each process flow contains at least one information element selected from the group consisting of instructions and data between the process steps.

At step 504, whatever components exist that carry out some or all of the process steps in the business process model are mapped onto the business process model, thereby providing a Service Oriented Package Integration Model. Each component is configured to carry out at least one process step. In the Service Oriented Package Integration Model, the components are connected together by the process flows.

At step 506, the process flows are reviewed to determine if there are any groups of process flows having at least a selected quantity of information elements in common. The selected quantity of information elements may be determined automatically by software, or alternatively may be input by a user. The selected quantity of information elements may vary depending on the type of information elements contained in the process flows. The selected quantity of information elements may be a first value for a certain type of information element and may be a second value for a second type of information element, wherein the first and second information elements are both contained by process flows in a single group. The selected quantity of information elements may vary depending on other factors, such as the quantity of process flows contained in a single group. The selected quantity of information elements may be selected based on a variety of other criteria in addition to, or alternatively to, the criteria described herein.

At step 508, if any group of process flows meet the selected criteria, then the group is identified and recorded as a potential integration point.

The software may use the integration points that have been identified to define services which can be incorporated into a service model for the business.

The method 500 may be applied in any suitable way. For example, it may be applied by examining each process flow individually, and then examining all other process flows in the Service Oriented Package Integration Model to determine if any groups can be formed. Alternatively, all the information elements relating to the process flows can be written to a table and the table can be manipulated in a way as to automatically generate groups based on selected criteria, such as the criteria described above. Other suitable ways of carrying out the method 500 may be used also.

It is possible for the above described methods to be carried out entirely manually. It is also possible, and advantageous for the methods described herein to be carried out manually or by automated means, such as by software. It is also possible for the methods described herein to be carried out by a combination of manual and automated means. It is possible for the above-described method to be carried out using a computer program product comprising at least one computer usable medium including computer-usable program code. It is possible to provide a data processing system comprising at least one processor, a bus coupled to the at least one processor, and at least one computer usable medium coupled to the bus, wherein the at least one computer usable medium contains a set of instructions and wherein the at least one processor is adapted to carry out the set of instructions by causing the data processing system to carry out the above described method.

In embodiments wherein one or more steps of the methods described herein are carried out using software, the coding of the software is within the skill of a person skilled in the art, after having read the description contained herein.

The invention can take the form of an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

We claim:

1. A method for identifying potential integration points within an enterprise system, the method comprising:
providing a suitably formatted business process model, the business process model comprising a plurality of interdependent process steps, wherein a plurality of components are provided, each component being configured to carry out at least one process step, wherein the plurality of components are connected together by a plurality of process flows, each process flow containing at least one information element selected from the group consisting of instructions and data between the process steps;
identifying a group of process flows having at least a selected quantity of information elements in common; and
recording the group of process flows as a potential integration point.

2. A method for identifying potential integration points within an enterprise system as claimed in claim 1, wherein the selected quantity is all of the information elements contained in the group of process flows.

3. A method for identifying potential integration points within an enterprise system as claimed in claim 1, wherein the selected quantity is a predetermined proportion of the information elements contained in the group of process flows.

4. A method for identifying potential integration points within an enterprise system as claimed in claim 1, wherein the business process model represents the entirety of at least one business function that is part of the enterprise system.

5. A method for identifying potential integration points within an enterprise system as claimed in claim 1, wherein the business process model represents the entirety of the enterprise system.

6. A method for identifying potential integration points within an enterprise system as claimed in claim 1, wherein the method is a computer-implemented method.

7. A data processing system comprising:
at least one processor;
a bus coupled to the at least one processor;
at least one computer usable medium coupled to the bus, wherein the at least one computer usable medium contains a set of instructions and wherein the at least one processor is adapted to carry out the set of instructions by causing the data processing system to:
provide a suitably formatted business process model, the business process model comprising a plurality of interdependent process steps, wherein a plurality of components are provided, each component being configured to carry out at least one process step, wherein the plurality of components are connected together by a plurality of process flows, each process flow containing at least one information element selected from the group consisting of instructions and data between the process steps;
identify a group of process flows having at least a selected quantity of information elements in common; and
record the group of process flows as a potential integration point.

8. A data processing system as claimed in claim 7, wherein the selected quantity is all of the information elements contained in the group of process flows.

9. A data processing system as claimed in claim 7, wherein the selected quantity is a predetermined proportion of the information elements contained in the group of process flows.

10. A data processing system as claimed in claim 7, wherein the business process model represents the entirety of at least one business function that is part of the enterprise system.

11. A data processing system as claimed in claim 7, wherein the business process model represents the entirety of the enterprise system.

12. A computer program product comprising at least one computer usable medium including computer-usable program code for identifying potential integration points within an enterprise system, said computer program product including:
computer-usable program code for providing a suitably formatted business process model, the business process model comprising a plurality of interdependent process steps, wherein a plurality of components are provided, each component being configured to carry out at least one process step, wherein the plurality of components are connected together by a plurality of process flows, each process flow containing at least one information element selected from the group consisting of instructions and data between the process steps;
computer-usable program code for identifying a group of process flows having at least a selected quantity of information elements in common; and
computer-usable program code for recording the group of process flows as a potential integration point.

13. A computer program product as claimed in claim 12, wherein the selected quantity is all of the information elements contained in the group of process flows.

14. A computer program product as claimed in claim 12, wherein the selected quantity is a predetermined proportion of the information elements contained in the group of process flows.

15. A computer program product as claimed in claim 12, wherein the business process model represents the entirety of at least one business function that is part of the enterprise system.

16. A computer program product as claimed in claim 12, wherein the business process model represents the entirety of the enterprise system.
